(19) United States
(12) Patent Application Publication
(10) Pub. No.: US 2013/0209902 A1
(43) Pub. Date: Aug. 15, 2013

(54) Fuel Cell System

(71) Applicant: Cosimo Mazzotta, Ulm (DE)

(72) Inventor: Cosimo Mazzotta, Ulm (DE)

(73) Assignee: Daimler AG, Stuttgart (DE)

(21) Appl. No.: 13/822,587

(22) PCT Filed: Aug. 24, 2011
(86) PCT No.: PCT/EP2011/004248

§ 371 Date: Apr. 30, 2013

(30) Foreign Application Priority Data
Sep. 18, 2010 (DE) 10 2010 046 012.5

(51) Int. Cl. H01M 8/04

(52) U.S. Cl. CPC H01M 8/04291
USPC 429/410

(57) ABSTRACT

A fuel cell system includes a fuel cell having a cathode chamber and an anode chamber. Exhaust gas from the anode chamber is conducted back to the inlet of the anode chamber in an anode circuit. A water separator is provided in the anode circuit, which is connected to a supply line to the cathode chamber by a drain line. A further water separator is arranged in the supply line upstream of the cathode chamber in the flow direction. The drain line flows into the supply line, upstream of the other water separator in the flow direction, or into the other water separator.

### BACKGROUND AND SUMMARY OF THE INVENTION

Exemplary embodiments of the present invention relate to a fuel cell system with at least one fuel cell.

Fuel cell systems are known from the general prior art. These fuel cell systems, particularly when they possess a sequence of PEM fuel cells, are often operated in such a way that a large amount of fresh hydrogen is fed into them on the anode side when this is absolutely necessary to operate the fuel cell. This facilitates the equal distribution of the hydrogen in the anode chamber of the fuel cell and thus enables ideal use of the active materials of the membrane and electrodes over the entire available surface. An exhaust gas flowing out of the anode chamber typically contains excess hydrogen and inert gases, particularly nitrogen, which is diffused into the anode chamber through the membranes of the fuel cell. Moreover, part of the product water present in the fuel cell is collected in the region of the anode chamber and is distributed by this anode exhaust gas therewith. To avoid wasting the hydrogen present in the anode exhaust gas, the exhaust gas is conducted back from the anode to the anode inlet and, from there, can be conducted back into the anode chamber of the fuel cell, along with fresh hydrogen.

This construction with a so-called anode circuit or anode loop also requires a water separator in order to separate the water accumulated in the anode circuit. Moreover, the gas should be discharged from the anode circuit, either continuously with minimal volumetric flow, or from time to time with a correspondingly larger volumetric flow, so as to flush out the nitrogen and other inert gases from the anode circuit in order to ensure that the hydrogen concentration is always sufficiently high during the operation of the fuel cell in the anode circuit.

Such a construction is known from PCT International Publication No. WO 2008/052578 A1, wherein, in the region of a single water separator, both the water discharge and the discharge of part of the exhaust gas take place. This can also be carried out using the drain/purge procedure in such a way that both the water and the gas are inserted into the region of a supply line to a cathode chamber of the fuel cell. This is essentially advantageous in that the excess hydrogen in the region of the electrocatalysts of the cathode chamber is abreacted in the gas, meaning that hydrogen emissions into the atmosphere can be securely and reliably avoided.

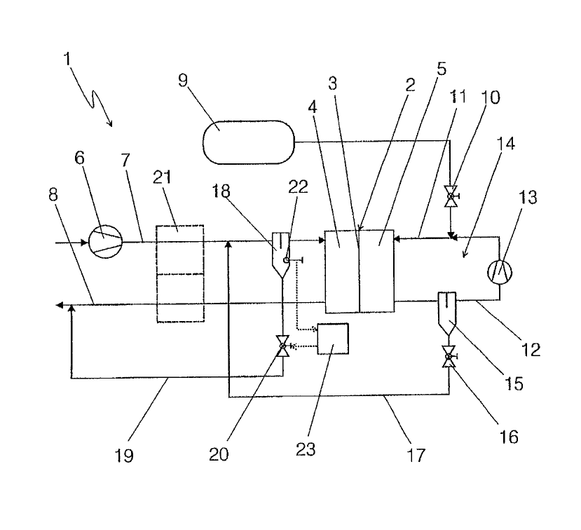

The disadvantage of the construction described, which is also described in a similar fashion in FIG. 2 of U.S. Patent Publication No. US 2010/0009223 A1, is that the liquid water is inserted into the region of the cathode chamber and thus individual regions of the cathode chamber or the membrane separating the cathode chamber from the anode chamber are dampened with water. This can lead to punctiform voltage drops or to voltage drops in the region of individual cells. Thus, with respect to operational strategy, the construction is comparatively complex, since discharge of the water/anode exhaust gas should ideally only take place when a sufficient air supply current is guaranteed. A control and operation method for such a fuel cell system is thus comparatively complex.

U.S. Patent Publication No. US 2004/0038100 A1 discloses a very complex fuel cell system, wherein both the hydrogen and the oxygen or air are humidified by the damp cathode exhaust gas. In order to avoid a large proportion of water in the humidified air supply and to prevent the infiltration of droplets into the fuel cell, water separators are arranged downstream of the corresponding humidifiers, in order to stop these droplets. In this construction, the exhaust gas from the anode circuit is, together with the exhaust gas from the cathode chamber, mixed after this dehumidification and released into the atmosphere via a further water separator.

Exemplary embodiments of the present invention avoid the above-mentioned disadvantages and to create a fuel cell system that enables a secure and reliable operation simply and efficiently, without the efficiency of the fuel cell system being compromised due to too high a water input into the cathode chamber.

According to exemplary embodiments of the present invention, a further water separator is thus provided, which is arranged in the supply line. In a different way from the constructions depicted in the above prior art, the water separator serves to separate water inserted from the supply to the cathode chamber of the fuel cell via the drain line of the water separator from the anode circuit. This water can then be discharged in a targeted manner, while the gases inserted into the region of the supply line, together with the water, can flow, in a completely separate manner from this water, into the cathode chamber of the fuel cell. The excess hydrogen contained therein can then abreact in the region of the electrocatalysts in order to avoid such hydrogen emissions from the fuel cell system. Using the further water separator in the supply line upstream of the cathode chamber has the essential advantage that, independent of the current operating status of the system and independent of the amount of supply to the system, even when the system is operative, the water and anode exhaust gas can be discharged. The strategy for discharging anode exhaust gas and water can also be carried out completely independently from the operative status of the fuel cell, in order to always guarantee the best possible hydrogen concentration in the region of the anode circuit.

It is only in situations where no oxygen is conveyed to the cathode chamber, so for example in a correspondingly designed stop operation of the fuel cell system, if this is operated as start/stop, that discharging water and gas should be dispensed with, since there is no oxygen available to convert the inserted hydrogen correspondingly in the region of the electrocatalysts of the cathode chamber. However, in all operative status in which there is at least a low level of supply flow flowing to the cathode chamber of the fuel cell, water and gas discharge can be carried out, since the amount of hydrogen being discharged is so low that even a very low supply flow is sufficient for avoiding hydrogen emissions.

In an advantageous development of the fuel cell system according to the invention, the further water separator can be connected to an exhaust line of the cathode chamber by a water delivery line. The water is inserted into the region of an exhaust line of the cathode chamber in a relatively direct route. Since a large portion of the product water present in the fuel cell is already contained in the exhaust of the cathode chamber, the additional water can be discharged simply and efficiently here. Potential measures for preventing the liquid water from leaving the fuel cell system can thus be used not only for the product water from the cathode chamber, but also for the product water from the anode chamber without requiring further constructive measures, if this is desired. According to whether a gas/gas humidifier, an enthalpy exchanger, an intercooler or similar is provided between the supply line and the exhaust line, the water can be inserted into the exhaust line from the region of the further water separator either before or after this. It can thus evaporate in the comparatively warm exhaust air and, where necessary, even be used to humidify the supply air.

Restrictors and/or valve devices are thus conceivable both for the water line and the drain line to influence the flow. For example, a continuous down-flow can take place via a restrictor and/or a controllable discharge can take place via an activated valve device, for example in a time-controlled manner or depending on the amount of water that has collected in the water separator or the further water separator. Combinations of valve devices and restrictors are also naturally conceivable, for example with a durable bypass arranged around a valve device, which enables continuous down-flow.

In an advantageous aspect of the fuel cell system according to the invention, at least one of the water separators includes a device for determining the water level, in the case that controllable valve devices are present, wherein the valve device is controlled or regulated in the flow direction downstream of this water separator, depending on the water level. It is then possible, with such a device for detecting the water level, which can be carried out either by at least one level sensor, by a processing unit for determining the water level by means of operating parameters of the fuel cell, or even by measuring the through-flow from the water separator to the further water separator, to control the valve device using the water level in the water separator. Discharge is thus ensured at least when a corresponding water level is reached. Particularly in the further water separator in the region of the supply line, it can moreover be ensured that only water is emitted into the region of the exhaust line, and the valve device is then always closed whenever excess water is still present in the water separator. Thus, the dispersal of hydrogen into the region of the exhaust line is safely and reliably prevented, and a reliable separation of the hydrogen in the direction of the cathode chamber and the water in the direction of the exhaust line is carried out via the further water separator according to the invention.

### BRIEF DESCRIPTION OF THE DRAWING FIGURE

The individually appended FIGURE shows a section of a fuel cell system.

### DETAILED DESCRIPTION

A fuel cell system 1 is to be identified in the FIGURE, which can ideally be used to provide electrical operating energy in a vehicle. It comprises a fuel cell 2, which is constructed, for example, as a sequence of individual cells. Here, the individual cells are preferably embodied with PEM technology and have a membrane 3, which separates a cathode chamber 4 from an anode chamber 5 of the fuel cell 2. Air is conducted into the cathode chamber 4 as oxygen delivery via an air conveyance device 6. This arrives at the region of the cathode chamber 4 via a supply line 7 and flows back via an exhaust line 8 out of the cathode chamber 4, depleted of oxygen. The exhaust air can then enter the atmosphere or, if desired, flow via suitable burners, turbines or suchlike beforehand, as is known in itself from the general prior art.

Hydrogen is conducted from a compressed gas storage unit 9 to the anode chamber 5 of the fuel cell 2 and arrives at the region of the anode chamber 5 via a hydrogen valve 10 and a hydrogen supply line 11. Unconsumed hydrogen in the region of the anode chamber 5 flows via a recirculation line 12 from the anode chamber 5 and arrives at the region of the hydrogen supply line 11 via a recirculation conveyance device 13. The exhaust gas is mixed here with fresh hydrogen from the compressed gas storage unit 9 and fed back into the anode chamber 5. The hydrogen supply line 11 and recirculation line 12 construction is also referred to as the anode circuit 14 or anode loop.

During the operation of the fuel cell 2, inert gases, in particular nitrogen, which diffuses through the membrane 3 from the cathode chamber 4 into the anode chamber 5, are concentrated in the region of the anode circuit 14 in time. Moreover, part of the product water of the fuel cell 2, which accrues in the region of the cathode chamber 5, collects in the anode circuit 14. Due to this, despite fresh hydrogen being added from the compressed gas storage unit 9, the hydrogen concentration is reduced in time at predetermined volumes of the anode circuit 14, running the risk of the anode chamber 5 being “flooded” with water located in the recirculation line. Thus, a water separator 15 is provided in the region of the recirculation line 12, which separates and collects the liquid water located in the region of the anode circuit 14. This water is discharged from the water separator 15 via the valve device 16 and a drain line 17, for example from time to time or when an appropriate amount of water has collected there. A corresponding long opening duration of the valve device 16 then guarantees that not only the collected water, but also a portion of the gas from the anode circuit 14, is discharged. This process is also known as drain/purge. By discharging a portion of the exhaust gas from the anode circuit 14, a large portion of the collected inert gases are discharged, typically together with a small portion of hydrogen. After the gases and water have been discharged, a very high hydrogen concentration is yet again present in the anode circuit 14, such that the fuel cell 2 can operate optimally.

The water, together with the exhaust gas from the anode circuit 14, arrives at the region of the supply line 7 to the cathode chamber 4 via the drain line 17. This construction ensures that the excess hydrogen contained in the exhaust gas reacts with the supply air that is conveyed by the air conveyance device 6 in the region of the cathode chamber 4 on the electrocatalysts of the cathode chamber 4, forming water. Hydrogen emissions into the atmosphere of the fuel cell system 1 are thus prevented. Since the amount of hydrogen discharged from the anode circuit 14 is typically low, the stress caused in this way on the catalysts and cathode chamber is minimal and even a small amount of air conveyed in the supply line 7 is sufficient to prevent hydrogen emissions.

In the construction of the fuel cell system 1, a further water separator 18 is then provided, which is arranged in the flow direction of the supply air flowing in the supply line 7 before entering the cathode chamber 4. As is depicted in the FIGURE, the drain line 17 flows upstream of the further water separator 18 into the supply line 7. In principle, it would also be naturally conceivable for the drain line 17 to flow directly into the water separator 18. It must only be ensured that the liquid water entering the supply line 7 via the drain line 17 is precipitated securely and reliably in the further water separator 18. It is thus achieved that it is not liquid water that is fed into the cathode chamber 4, but rather the inert gases and the excess hydrogen from the anode circuit 14. The liquid water is additionally precipitated via the further water separator 18 and arrives at the region of the exhaust line 8 from the cathode chamber 4 via a water delivery line 19. In the representation of the FIGURE, a further valve device 20 is also depicted in the region of the water delivery line 19. As well as using the valve device 20, it would also be conceivable to use a restrictor, such that there is continuous volume flow through the water delivery line 19. This also applies comparably for the valve device 16 in the region of the drain line 17, which could also be replaced by a restrictor. The combination of a valve device for discharging larger volume flows and a parallel bypass having a baffle for guaranteeing a continuously low volume flow would naturally also be conceivable.

The design of the fuel cell system 1 depicted here can also possess an optional gas/gas humidifier, enthalpy exchanger and/or intercooler between the supply line 7 and the exhaust line 8. This is optionally denoted in the form of a gas/gas humidifier 21, for example.

The construction of the fuel cell system 1, as is denoted in the individually appended FIGURE, now has the advantage that gas and water discharge can thus take place from the region of the anode circuit 14 in the same highly flexible manner as is required for the ideal performance of the fuel cell 2 and thus the ideal hydrogen concentration provided in the anode chamber 5. Due to the fact that water is not inserted into the region of the cathode chamber 4, but rather precipitated via the further water separator 18, only a minimal volume flow of air in the supply line 7 is sufficient to prevent hydrogen emissions securely and reliably. A strategy for discharging water and gas from the anode circuit 14 can thus take place, in particular independent of the size of the supply air flow.

Ideally, the further water separator 18 is thereby equipped with a device for detecting the water level. This is denoted in the representation of the individually appended FIGURE by a water level sensor 22. An activation of the valve device 20 can take place via the water level sensor 22 and a control device 23 assigned thereto in such a way that only water is discharged from the region of the further water separator 18 and there is always a minimal amount of excess water remaining in the region of the water separator 18 or in the region of the water delivery line 19 before the valve device 20. Hydrogen in the exhaust gases from the anode circuit 14 can thus be prevented securely and reliably from arriving at the region of the exhaust line 8 and thus from entering the environment, since there is always a corresponding water cap between the valve device 20 and the further water separator 18 and the supply line 7, such that excess hydrogen always flows into the region of the cathode chamber 4 and only water flows off via the water delivery line 19.

The water level sensor 22 denoted as an example can thereby be arranged in the form of two water level sensors in the region of the water separator 18. Alternatively, in principle, the use of a single water level sensor would also be conceivable, which can be switched in such a way that it always opens the valve device 20 when it is humidified and closes it when it is dry. Due to an artful arrangement of the sensor in the water separator 18 and the use of the unavoidable hysteresis of the sensor, the desired object can be securely and reliably fulfilled with a single sensor. As well as such a so-called level sensor for detecting the water level, it would also be naturally conceivable to calculate the water level with the control device 23 by means of a suitable simulation based on operating parameters of the fuel cell, in particular the electrical power output thereof, since the mechanisms in the fuel cell are so well known that the amount of water incidental in the region of the anode chamber can be estimated very accurately as the amount of water conducted. Additionally or alternatively to this, it would be furthermore conceivable to detect and/or estimate the amount of water collected in the further water separator 18 via a through-flow measurement in the region of the drain line 17.

The devices described for the further water separator 18 can of course also be present for the water separator 15, additionally or alternatively, so as to have an influence on the water discharge and the discharge of exhaust gas from the anode circuit 14 accordingly.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A fuel cell system, comprising:
at least one fuel cell, with a cathode chamber and an anode chamber, wherein an exhaust gas from the anode chamber is conducted back to an inlet of the anode chamber via an anode circuit;
a water separator arranged in the anode circuit, wherein the water separator is connected to a supply line to the cathode chamber by a drain line;
a further water separator arranged in the supply line in a flow direction upstream of the cathode chamber, wherein the drain line is configured to flow into the supply line in a flow direction upstream of the further water separator, and wherein the further water separator is connected to an exhaust line of the cathode chamber by a water delivery line; and
a valve device arranged in a region of the water delivery line between the further water separator and the exhaust line,
wherein at least one of the water separator and the further water separator includes a device configured to detect a water level, wherein the valve device is controllable in a flow direction downstream of this water separator depending on the water level of the respective water separator.

12. The fuel cell system according to claim 11, wherein the further water separator includes the device configured to detect the water level.

13. The fuel cell system according to claim 11, further comprising:
a restrictor arranged in a region of the water delivery line between the further water separator and the exhaust line.

14. The fuel cell system according to claim 11, further comprising:
a restrictor arranged in a region of the drain line between the water separator and the supply line.

15. The fuel cell system according to claim 11, further comprising:
a valve device arranged in a region of the drain line between the water separator and the supply line.

16. The fuel cell system according to claim 11, wherein the device configured to detect the water level is at least one water level sensor.

17. The fuel cell system according to claim 11, wherein the device configured to detect the water level includes a calculating unit configured to calculate the water level using operating parameters of the fuel cell or to estimate the water level by simulation.

18. The fuel cell system according to claim 11, wherein the device configured to detect the water level uses through-flow measurement of the water in a region of the drain line.

19. A fuel cell system, comprising:
at least one fuel cell, with a cathode chamber and an anode chamber, wherein an exhaust gas from the anode chamber is conducted back to an inlet of the anode chamber via an anode circuit;
a water separator arranged in the anode circuit, wherein the water separator is connected to a supply line to the cathode chamber by a drain line;
a further water separator arranged in the supply line in a flow direction upstream of the cathode chamber, wherein the drain line is configured to flow directly into the further water separator, wherein the further water separator is connected to an exhaust line of the cathode chamber by a water delivery line; and
a valve device arranged in a region of the water delivery line between the further water separator and the exhaust line,
wherein at least one of the water separator and the further water separator includes a device configured to detect the water level, wherein the valve device is controllable in a flow direction downstream of this water separator depending on the water level of the respective water separator.

20. The fuel cell system according to claim 19, wherein the further water separator includes the device configured to detect the water level.

21. The fuel cell system according to claim 19, further comprising:
a restrictor arranged in a region of the water delivery line between the further water separator and the exhaust line.

22. The fuel cell system according to claim 19, further comprising:
a restrictor arranged in a region of the drain line between the water separator and the supply line.

23. The fuel cell system according to claim 19, further comprising:
a valve device arranged in a region of the drain line between the water separator and the supply line.

24. The fuel cell system according to claim 19, wherein the device configured to detect the water level is at least one water level sensor.

25. The fuel cell system according to claim 19, wherein the device configured to detect the water level includes a calculating unit configured to calculate the water level using operating parameters of the fuel cell or to estimate the water level by simulation.

26. The fuel cell system according to claim 19, wherein the device configured to detect the water level uses through-flow measurement of the water in a region of the drain line.
